(19) United States
(12) Patent Application Publication
(10) Pub. No.: US 2023/0280038 A1
(43) Pub. Date: Sep. 7, 2023

(54) BURNER SYSTEM FOR ADVANCED GRILL

(71) Applicant: W.C. Bradley Co., Columbus, GA (US)

(72) Inventors: Christopher J. Bennett, Opelika, AL (US); SLEIMAN ABDALLAH, Columbus, GA (US); RAMIN KHOSRAVI RAHMANI, Columbus, GA (US); Thomas Kessler, Columbus, GA (US); BRUCE ROBERTS, Phenix City, AL (US)

(21) Appl. No.: 18/113,265

(22) Filed: Feb. 23, 2023

Related U.S. Application Data
(60) Provisional application No. 63/313,165, filed on Feb. 23, 2022.
(60) Provisional application No. 63/356,772, filed on Jun. 29, 2022.

(51) Int. Cl. F24C 3/08; F23D 23/00; F24C 3/12; F23N 1/00; A47J 37/07

(52) U.S. Cl. CPC F24C 3/085; F23D 23/00; F24C 3/126; F23N 1/005; A47J 37/0786; A47J 37/0713; F23N 2225/14; F23N 2235/16

(57) ABSTRACT

A burner system for use in a gas cooking grill has a primary burner in a firebox providing heat to a cooking surface above the primary burner and a secondary burner in the firebox selectively providing heat to a cooking grate such that ignition of the secondary burner provides an additional degree of heat to the cooking surface above the primary burner.

### CROSS-REFERENCE TO RELATED CASES

This application claims the benefit of U.S. provisional patent application Ser. No. 63/313,165, filed on Feb. 23, 2022 and 63/356,772, filed on Jun. 29, 2022, and incorporates such provisional applications by reference into this disclosure as if fully set out at this point.

### FIELD OF THE INVENTION

This disclosure relates to gas grills in general and, more specifically, to an improved burner system for a gas grill.

### BACKGROUND OF THE INVENTION

Gas grill burners have assumed various configurations over years. In some cases, burners are stamped as top and bottom pieces and joined together in some way to form a plenum chamber with an inlet area for an air/gas mixture, and peripheral or top arranged small ports for exit and combustion of the air/gas mix. In many other cases the burners for gas grills are constructed as tubes with an aspirating inlet for mixing air with gas and small burner ports along the length of the tube. Both types of burners are limited in terms of the ratio of maximum gas flow rate to minimum gas flow rate, defined as the turn down ratio. For gas grill products typical turn down ratios are in the neighborhood of 2:1.

When it is desired to have an automatic modulating burner system, this turndown ratio will still apply. In prior systems, the performance of automatic burner systems is limited by the turndown ratio, which limits the minimum temperature achievable by the system (typically to be found in the range of 400° F. to 500° F.). This limitation exists even with a manually controlled system, which means that some kinds of slow cooking (e.g., of large thickness of meat) is not a practical proposition.

What is needed is a burner system suited for, but not limited to, automatic modulating control that can produce a greater effective cooking temperature range and/or address the above and related issues.

### SUMMARY OF THE INVENTION

The invention of the present disclosure, one aspect thereof, comprises a burner system for use in a gas cooking grill. The system includes a primary burner in a firebox providing heat to a cooking surface above the primary burner, and a secondary burner in the firebox selectively providing heat to a cooking grate such that ignition of the secondary burner provides an additional degree of heat to the cooking surface above the primary burner.

In some embodiments, the primary burner and secondary burner provide heat to a same area of the cooking surface. The primary burner may be nested within the secondary burner. The burner system may comprise a conduit for transferring ignitable gases between the primary burner and secondary burner.

In some embodiments, a gas control mechanism selectively activates the secondary burner. The gas control mechanism may be thermostatic.

A turndown ratio of the burner system may exceed 2:1, and may be about 5:1.

In some cases, the secondary burner comprises a plurality of secondary burners. The system may include a baffle interposing two of the plurality of secondary burners.

Some embodiments further comprise a horizontal baffle interposing a portion of the primary burner, and a portion of the secondary burner, below and the cooking surface above. The horizontal baffle may be above a portion of the primary burner running parallel to a portion of the secondary burner.

The invention of the present disclosure, in another aspect thereof, comprises a burner system for use in a gas grill. The system has a primary burner below a cooking surface in the grill, a secondary burner below the cooking surface in the grill, a control module, a temperature sensor; and a gas control valve controlling gas flow to the secondary burner. The primary and secondary burners are arranged such that they both heat a same area of the cooking surface. The primary and secondary burner are also arranged such that the primary burner ignites the secondary burner when gas flows into the secondary burner. The control module controls gas flow to the secondary burner via the gas control valve thermostatically based on the a temperature obtained using the temperature sensor.

In some embodiments, the primary and secondary burners are in a common plane and the secondary burners at least partially surrounds the primary burner. The primary and secondary burner may be parallel to one another along portions thereof. In some embodiment, the primary burner and secondary burner are orthogonal to one another. Some embodiments comprise an additional secondary burner arranged such that the primary burner ignites the additional secondary burner when gas flows into the additional secondary burner.

The invention of the present disclosure, in another aspect thereof, comprise a grill with a firebox having a cooking surface, a fuel supply, a primary burner below the cooking surface and receiving fuel from the fuel supply via a primary electronically controlled gas valve. A secondary burner is below the cooking surface and receives fuel from the fuel supply via a secondary electronically controlled gas valve. The grill has a temperature probe in the firebox, and a control module that controls the primary electronically controlled gas valve and the secondary electronically controlled gas valve to increase or decrease output from the primary burner and the secondary burner, respectively. The control module thermostatically controls at least the secondary gas valve based on a temperature reading using the temperature probe. The primary burner and secondary burner are arranged below the cooking surface to each heat a same area of the cooking surface.

In some embodiments, a turndown ratio of a highest setting of the primary burner and secondary burner and a lowest setting of the primary burner and secondary burner is about 5:1. In some cases a flame pathway exists between the primary burner and secondary burner such that the secondary burner can be turned completely off and then ignited by the primary burner when gas flows from the secondary burner.

### BRIEF DESCRIPTION OF THE DRAWINGS

FIG. 1 is a perspective view of a gas grill according to aspects of the present disclosure.

FIG. 2 is closeup perspective view of a gas grill incorporating a burner system according to aspects of the present disclosure.

FIG. 3 is a closeup perspective view of the gas grill and burner system of FIG. 2 with a heat baffle in place.

FIG. 4 is a closeup perspective view of a gas grill incorporating another burner system according to aspects of the present disclosure.

FIG. 5 is a closeup perspective view of a gas grill incorporating another burner system according to aspects of the present disclosure.

FIG. 6 is a schematic diagram of a burner system for a gas grill according to aspects of the present disclosure.

FIG. 7 is a closeup perspective cutaway view of a gas grill with separated burners.

FIG. 8 is a closeup perspective cutaway view of a gas grill incorporating a burner system according to the present disclosure.

### DETAILED DESCRIPTION OF THE PREFERRED EMBODIMENTS

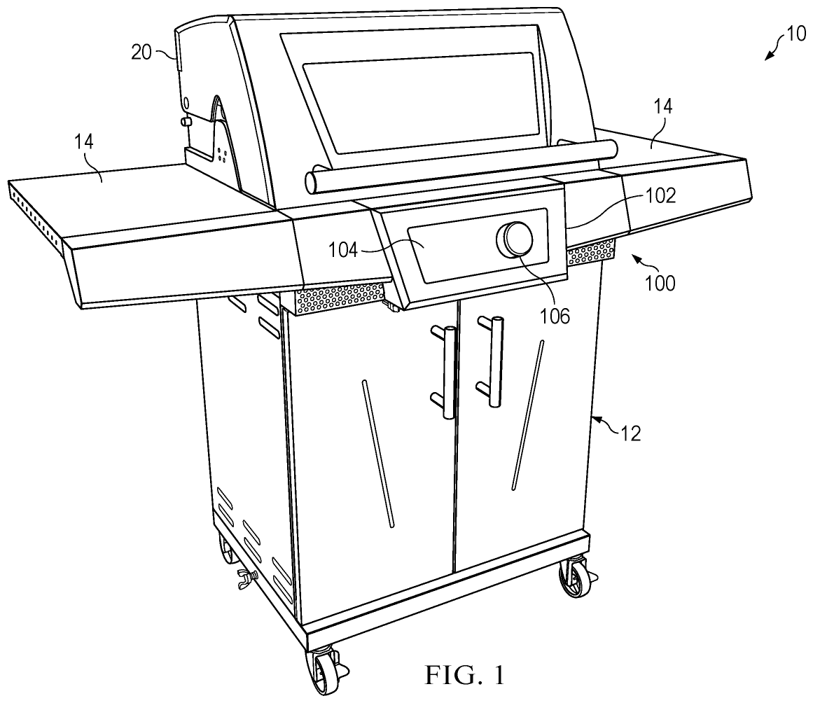

Referring now to FIG. 1 is a perspective view of a gas grill 10 according to aspects of the present disclosure is shown. Various embodiments of the present disclosure provide a burner system suitable for a gas grill. The gas grill 10 is an exemplary embodiment of such a gas grill that may utilize a burner system according to the present disclosure. It should be understood that, at least externally, such a gas grill may have an appearance that varies from the exemplary gas grill 10.

As shown the grill 10 comprises a firebox 100, which may contain a burner system 101 according to the present, as discussed further below. An openable lid 20 may cover the firebox 100. The lid 20 may be hinged at the rear or have another opening known to the art. The grill 10 may comprise a cart 12, a cabinet, or another support placing the firebox 100 at a convenient height for the user. Storage may be provided in the cart 12 as is known in the art. Side shelves 14 and other convenience features may also be provided.

The grill 10 has various options for control of the device. The grill 10 may comprise a control module 102. The control module may include one or more temperature knobs 106 and/or other temperature controls. A display screen 104 may also be provided for indicating cooking temperature and other parameters. In other embodiments, the grill 10 may include different control panels, mechanism, and/or indicators or displays as are known to the art.

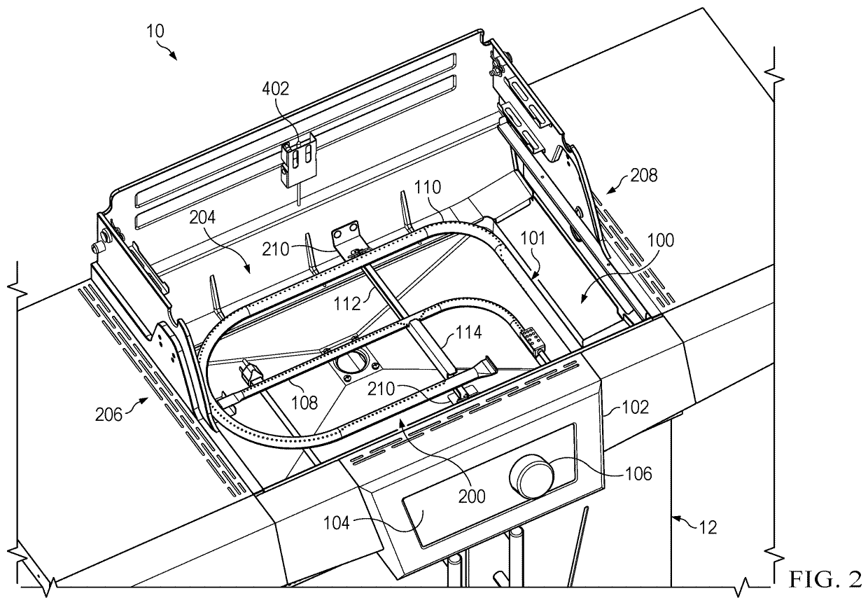

Referring now to FIG. 2 a closeup perspective view of the gas grill 10 is shown. The grill 10 is shown in FIG. 2 without cooking grates and openable lid 20, for clarity. The firebox 100 may be square, rectangular, or otherwise rectilinear when viewed from above. Whether the firebox 100 is rectilinear or otherwise, the firebox 100 may be said to have a front 200, a back 204, a left side 206, and a right side 208. These directions and orientations are with respect to the view of a user standing at the grill 10.

In the illustrated embodiment, the burner system 101 comprises a primary burner 108 and a secondary burner 110. The primary burner 108 may be nested within the secondary burner 110, and they may be within the same plane or generally the same plane below the cooking surface. The primary burner 108 and a secondary burner 110 may both enter the firebox 100 in a front to back direction (e.g., from the front 200 toward the back 204). The entry of the burners 108, 110 may be generally parallel and coplanar with one another, and may be toward the left side 206, or right 208 side of the firebox 100. The burners 108, 110 are illustrated as entering the firebox 100 nearer the right side 208. In such case, the primary burner 108 may then turn at approximately the lateral midline of the firebox 100 (e.g., midway between the front 200 and back 204) to run in a left to right direction toward the left side 206 of the firebox 100.

The secondary burner 110 may continue from its entrance in the front to back direction to a position close to the back 204 of the firebox 100 and then turn to run in a left to right direction toward the left side 206 of the firebox 100. The secondary burner 110 may be formed in a generally semi-circular path moving back to a position close to the front 200 of the firebox 100. The secondary burner 110 may then extend in the left to right direction until it reaches a point short of the primary burner entrance to the firebox. It will be understood that the burner entrance can be at the right side of the firebox with the burners 108, 110 elements extending to the left or vice versa.

Arrangements may be made to connect the two burners 108, 110 into a unitary assembly or burner system 101 by appropriate brackets (e.g., a bracket 112) and formation of the burner tubes using welding or fasteners as known in the art. Further there may be at least one gas conduit (e.g., 114) that connects the primary burner 108 to the secondary burner 110 for purposes of spreading ignition or flame. This conduit 114 may be associated with some of the connection hardware between the primary and secondary burners, such as the bracket 112. The entire assembly or burner system 101 may be mounted into the firebox 100 on brackets 210 with spring pins or other securements that do not require the use of tools to assemble.

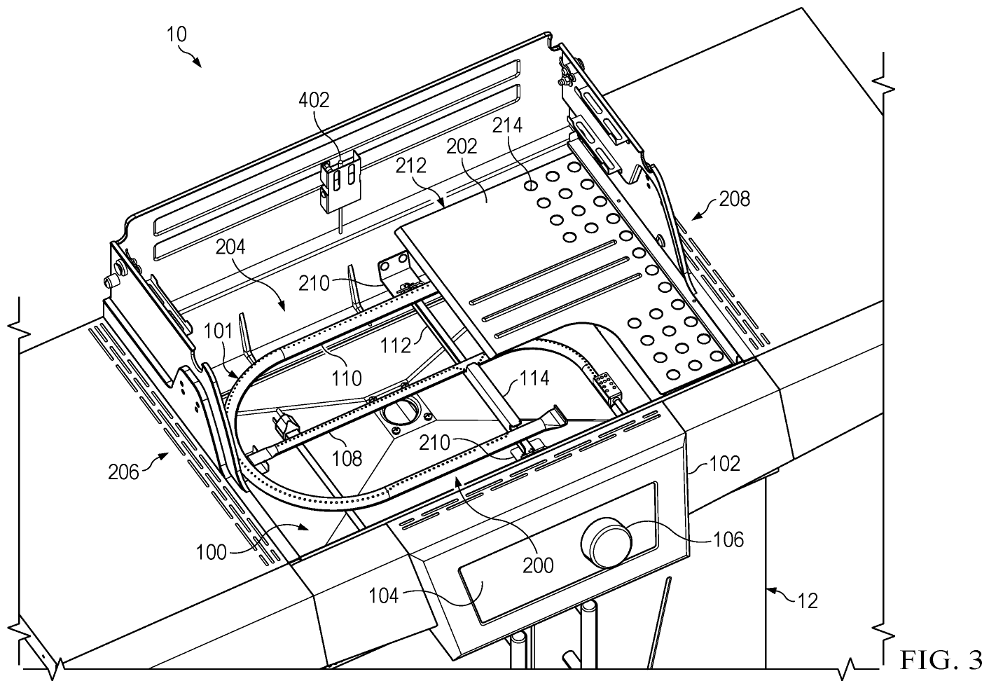

Referring now to FIG. 3, a closeup perspective view of the gas grill 10 and burner system 101 of FIG. 2 with a heat baffle 212 in place is shown. In the illustrated embodiment having an asymmetrical configuration, it may be desirable to utilize a baffle 212 to better distribute the hot gases produced by the burners 108, 110. This may take the form of a horizontally arranged generally flat plate 202, which may have some number of openings 214 to allow passage of hot gas. The baffle 212 may be placed over the area where the primary burner 108 and secondary burner 110 enter the firebox 100 and below the cooking grate (not shown) which is placed across the open top of the firebox 100. Here the baffle has somewhat of an “L-shape” and fits into the corner at the back 204 and right side 208 of the firebox 100. Openings 214 are defined in the baffle 212 near front and rear portions of the side 208 of the firebox 100 where additional convection may be needed for even heating.

The baffle 212 may be configured or placed other than shown in order to achieve the desired even heating effect, particularly where the two burners 108, 110 converge or are closest together. The shape of the baffle 212 may depart from the example shown, as may the number and placement of openings 214 in the baffle 212.

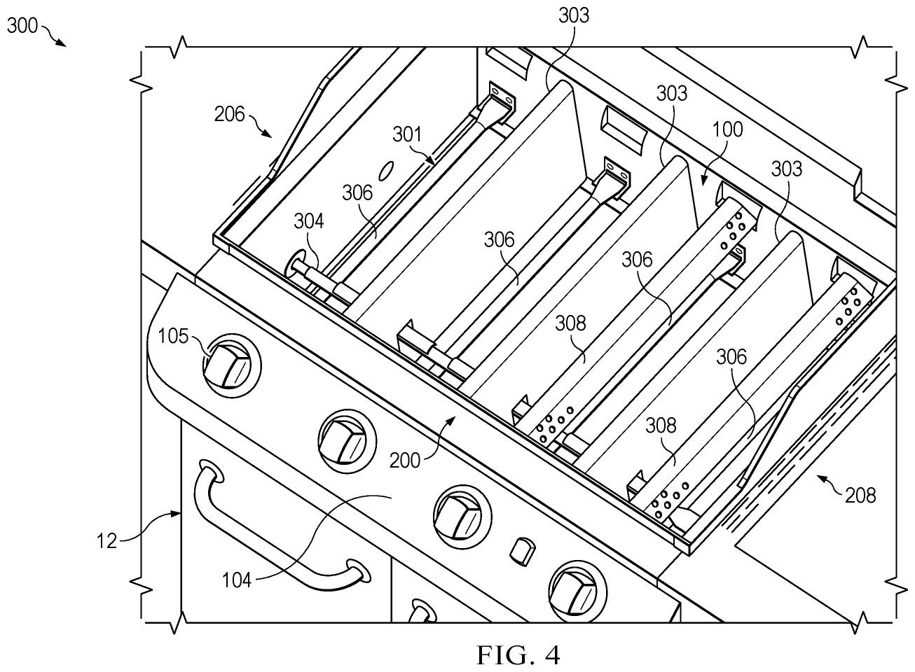

Referring now to FIG. 4, a closeup perspective view of a gas grill 300 incorporating another burner system 301 according to aspects of the present disclosure is shown. Lids and cooking grates are not shown, for illustrative purposes. The firebox 100 may be configured as in previous embodiments with front side 200, back side 204, left side 206, and right side 208 labelled for clarity. The firebox 100 may sit atop a cart 12 as before. A control module 302 is provided near the front side 200 and may differ in appearance from the control module 104. A display screen may or may not be provided. However, knobs or other controls may be used to control temperature or gas settings.

The burner system 301 may comprise a primary burner 304 extending generally from left to right in the firebox 100, and may have one or more secondary burners 306 extending generally from front to back. The primary burner 304 may be generally orthogonal to, or at a right angle to, the secondary burners 306. The primary burner 304 may be arranged either above or below the secondary burner(s) 306 and arrangements of gas ports on the primary burner 304 and secondary burners 306 is such that reliable carry over of ignition from the primary burner 304 to secondary burner 306 occurs.

The primary burner 304 may be generally to the front 200 of the firebox 100, generally to the rear 204 of the firebox 100, or generally along a lateral mid-line of the firebox 100 as might be deemed most appropriate to optimize heat distribution in different heating modes. In this embodiment the primary burner 304 and secondary burners 306 may be assembled as separate pieces or may be a unitary assembly. In one mode of operation, the primary burner 304 is located to heat the entire cooking surface (not shown) with up to all of the secondary burners 306 providing additional heat output for the entire cooking surface. In another mode of operation, the secondary burners 306 may be used individually to achieve different heating properties at different cooking locations (whether the primary burner 304 is active or not).

Baffles 303 may be placed between secondary burners 306 to control heat flow and/or to provide isolation if the secondary burners 306 are operated to provide disparate level of heat for different cooking areas. Heat tents 308, heat spreaders, baffles, and other implements may be used to control heat or convection within the firebox 100 and cooking grill in general.

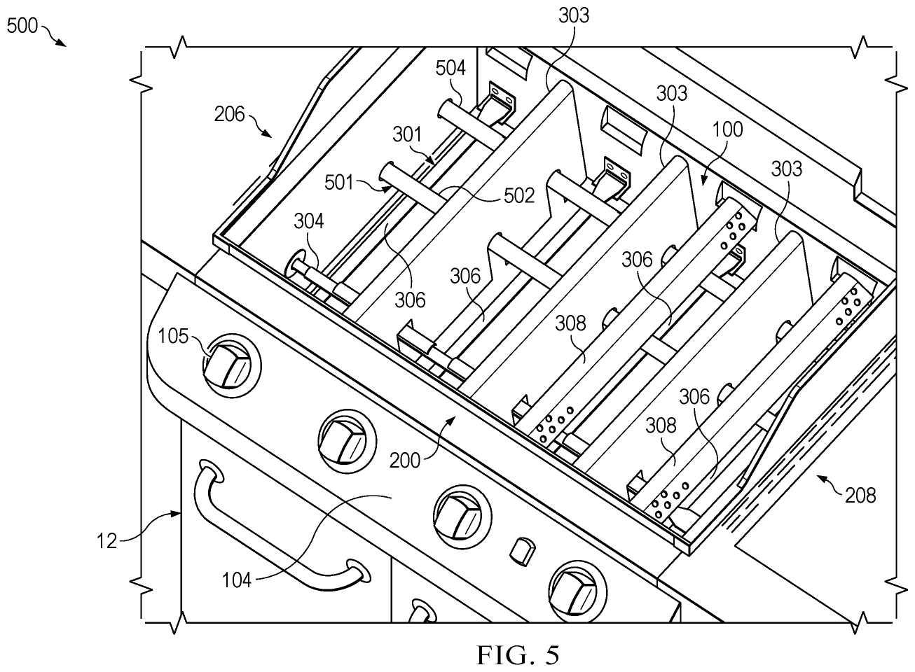

Referring now to FIG. 5 a closeup perspective view of a gas grill 500 incorporating another burner system 501 according to aspects of the present disclosure is shown. The grill 500 and the burner system 501 are substantially similar to the grill 300 and burner system 301, respectively, of FIG. 3 but with the addition of primary burners 502 and 504 in the firebox 100. Primary burners 502, 504 may function in the same or a similar manner as primary burner 304.

In some embodiments, primary burner 502 is placed approximately midway (front to rear) in the firebox 100 but is otherwise placed similarly to primary burner 304. The primary burner 502 may be placed above or below the secondary burner(s) 306 with arrangements of gas ports on the primary 502 burner and secondary burners 306 is such that reliable carry over of ignition from the primary burner 502 to secondary burner 306 can occur.

Primary burner 504 may be placed near a back side of the firebox 100 but is otherwise placed similarly to primary burner 304. The primary burner 504 may be placed above or below the secondary burner(s) 306 with arrangements of gas ports on the primary 502 burner and secondary burners 306 is such that reliable carry over of ignition from the primary burner 504 to secondary burner 306 can occur.

While embodiments having a single primary burner spanning left to right near the front 200 of the firebox 100 (e.g., FIG. 3) and embodiments with multiple primary burners 304, 502, 504 spanning left to right and arranged front to back in the firebox (e.g., FIG. 5) are shown, it should be appreciated that a single primary burner may be placed other than as shown in FIG. 3. For example, a single primary burner could be placed midway (e.g., burner 502) or toward the rear (e.g., burner 504) of the associate firebox. Similarly, a primary burner may be placed other than the locations shown so long as it is arranged with respect to the secondary burners 306 to provide reliable carry over ignition of the secondary burners. It should also be appreciated that two primary burners may be used, or four or more, where grill size and desired cooking control dictates. In some embodiments the orientation of the primary burner(s) and secondary burners(s) is be reversed from that shown. In other words, primary burners run front to back and secondary burners run left to right.

In embodiments with multiple primary burners, all of these may be operated at once, or only a subset. Thus, even more control over cooking operations is provided. Where more than one primary burner is used, it may be possible to achieve ignition of the secondary burners regardless of which primary burner(s) is in operation. A control system associated with a grill having multiple primary burners may be configured to allow for selection of which primary burner(s) to operate, with or without of operation of the secondary burner(s).

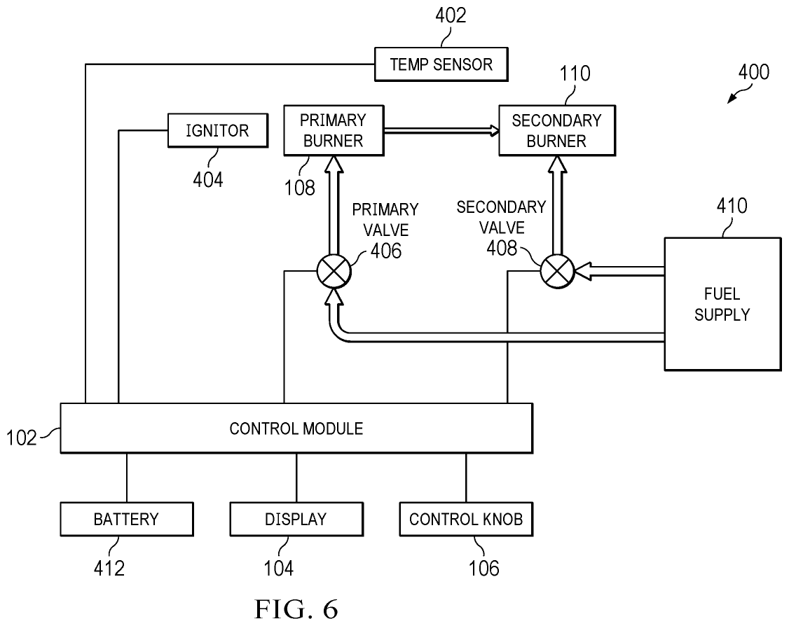

Referring now to FIG. 6, schematic diagram of a control system 400 for a gas burner system according to the present disclosure is shown. Although the control system 400 is shown in the context of a single primary burner 108 and a single secondary burner 112, such as might be found in a burner system 101 of FIG. 2, it should be appreciated that the control system 400 can readily be adapted for use with systems that have multiple primary and/or secondary burners.

Regardless of the physical embodiment, the control system 400 may comprise a control module 102 with a control panel comprising a temperature display 104 and a temperature adjustment mechanism 106, which may be a knob, slider, or other control. The control module 102 may be based on one or more integrated circuit chips as are known in the art. The control module 102 may be programmable or reprogrammable by one skilled in the art to carry out the functions described herein. Necessary auxiliary circuitry including, but not limited to, AC/DC converters, relays, amplifiers, and RC networks may be employed as needed.

The control system 400 may include a pair of electrically controlled gas valves 406, 408 corresponding to the primary burner 108 and secondary burner 112, respectively. In embodiments with additional burners, these may have additional valves controlling gas flow thereto. It may be the case that the pair of valves 406, 408 (and possible other valves) are combined in a common body for reasons of convenience. The gas valves 406, 408 (and others, if present) may be controlled by the control module 102

In some embodiments, a backup battery power source 412 provides power (direct current) current to the control module 102 and valves if AC household power is unavailable.

An ignitor 404 may be used to ignite the primary burner 108 and may be controlled by the control module 102. If more than a single primary burner is utilized, each may have an ignitor associated therewith.

A temperature sensor 402 may be provided at a suitable location on or near the cooking surface or in the firebox providing temperature data to the control module 102. The temperature sensor 402 may comprise a temperature probe, a thermometer, a thermocouple, or other device capable of reliably taking a temperature reading electronically for use by the control module 102.

A fuel supply 410 may comprise a gas source as known in the art.

Alternatively, if thermostatic control is not desired, a simpler control system than the system 400 may be utilized. Such a system may have two manually operated gas valves, for example, and an ignition mechanism as known in the art.

The burner systems of the present disclosure (e.g., 101, 301, 501) are designed to create an even heating distribution when multiple burners are lit, reliably ignite from the flame of the primary burner to the secondary burner(s), and maintain even heat when only the primary burner(s) is lit.

In operation, a primary burner may always be lit and operating either at a fixed rate or at a controllable rate. This burner may be configured to produce relatively even low heat over the entire cooking area, and also act as a pilot ignition source to a secondary burner (or burners) which are turned on and off to provide modulated heat control over the entire cooking area. Various embodiments of the present disclosure give a much higher heat range over the full cooking surface. Effective turndown ratio is in the range of 5:1. This allows thermostatically controlled cooking over a much higher temperature range over the full cooking area of the appliance. This makes it possible to cook a wider range food types with different styles of cooking, which may not otherwise be possible.

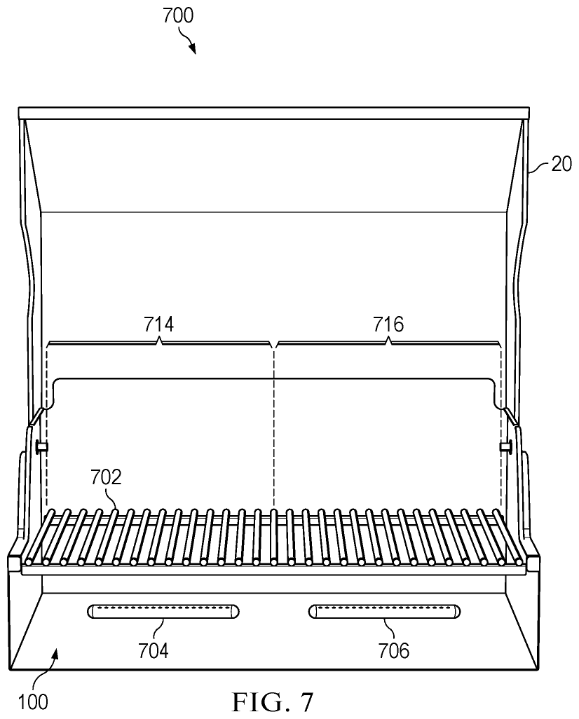

It should also be appreciated that various embodiments of the present disclosure utilize multiple separately controlled burners to apply heat to the same area of a cooking surface. Referring now to FIG. 7, an example of a gas grill 700 operating with burners 704, 706 is shown in front perspective cutaway. The grill 700 provides the burners 704, 706 below a cooking surface 702 in the firebox 100. For illustrative purposes, the cooking surface 702 is a grate divided into area 714, nearest burner 704, and area 716, nearest burner 706. In a typical arrangement, burners 704, 706 are arranged such that burner 704 primarily heats area 714, and burner 706 heats area 716.

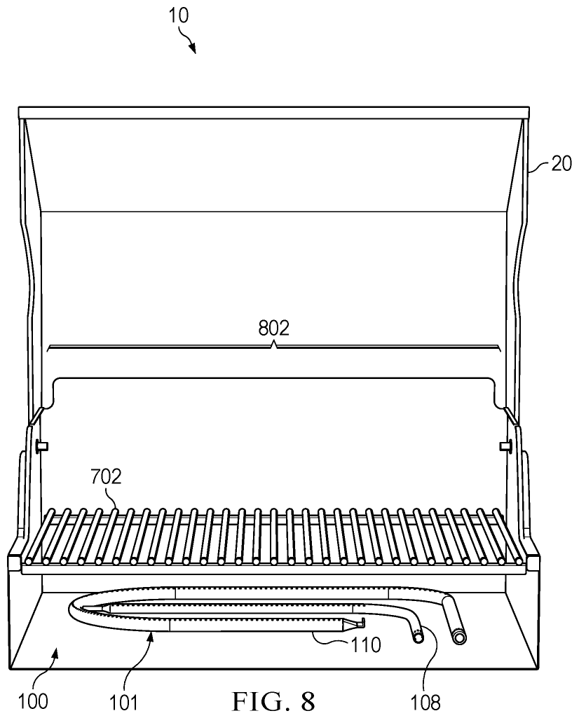

Referring now to FIG. 8, the grill 10 of FIGS. 1-3 is shown in front perspective cutaway. Here with the burner system 101 in the firebox 100 below the cooking surface 702 it can be seen that both the primary burner 108 and the secondary burner 110 heat a common cooking area 802. The area 802 may span the entire grate 702 as shown. However, this is not necessarily the case as the primary burner 108 and secondary burner 110 may each heat a common cooking area that occupies less than the entire grate 702. However, it may remain the case that they heat a common area such that the benefits of increase turndown ratio and wide heating ranges are available at least on the common area. The arrangement of the burners 108, 110 in the system 101 in the grill 10 is such that multiple burners are used not to expand or contract the area heated but to increase the range or degree of heating available over a the area.

In various embodiments of the present disclosure, the cooking surface 702 may be similar to that shown and described in U.S. Pat. No. 10,034,577, hereby incorporated by reference. However, an open and predominately convective cooking grate could be used. In the case of an open cooking grate, provisions such as tent structure or shields may be used to prevent grease ingress to the gas ports of the burners 108, 110.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A burner system for use in a gas cooking grill comprising:
a primary burner in a firebox providing heat to a cooking surface above the primary burner; and
a secondary burner in the firebox selectively providing heat to a cooking grate such that ignition of the secondary burner provides an additional degree of heat to the cooking surface above the primary burner.

2. The system of claim 1, wherein the primary burner and secondary burner provide heat to a same area of the cooking surface.

3. The system of claim 2, wherein the primary burner is nested within the secondary burner.

4. The system of claim 3, further comprising a conduit for transferring ignitable gases between the primary burner and secondary burner.

5. The system of claim 4, further comprising a gas control mechanism that selectively activates the secondary burner.

6. The system of claim 5, wherein the gas control mechanism is thermostatic.

7. The system of claim 1 wherein a turndown ratio of the burner system exceeds 2:1.

8. The system of claim 7 wherein the turndown ratio of the burner system is about 5:1.

9. The system of claim 1, wherein the secondary burner comprises a plurality of secondary burners.

10. The system of claim 9, further comprising a baffle interposing two of the plurality of secondary burners.

11. The system of claim 1, further comprising a horizontal baffle interposing a portion of the primary burner, and a portion of the secondary burner, below and the cooking surface above.

12. The system of claim 11, wherein the horizontal baffle is above a portion of the primary burner running parallel to a portion of the secondary burner.

13. A burner system for use in a gas grill comprising:
a primary burner below a cooking surface in the grill;
a secondary burner below the cooking surface in the grill;
a control module;
a temperature sensor; and
a gas control valve controlling gas flow to the secondary burner;
wherein the primary and secondary burner are arranged such that they both heat a same area of the cooking surface;
wherein the primary and secondary burner are arranged such that the primary burner ignites the secondary burner when gas flows into the secondary burner;
wherein the control module controls gas flow to the secondary burner via the gas control valve thermostatically based on the a temperature obtained using the temperature sensor.

14. The burner system of claim 13, wherein the primary and secondary burner are in a common plane and the secondary burner at least partially surrounds the primary burner.

15. The burner system of claim 14, wherein the primary and secondary burner are parallel to one another along portions thereof.

16. The burner system of claim 13, wherein the primary burner and secondary burner are orthogonal to one another.

17. The burner system of claim 13, further comprising an additional secondary burner arranged such that the primary burner ignites the additional secondary burner when gas flows into the additional secondary burner

18. A grill comprising:
a firebox having a cooking surface;
a fuel supply;
a primary burner below the cooking surface and receiving fuel from the fuel supply via a primary electronically controlled gas valve;
a secondary burner below the cooking surface and receiving fuel from the fuel supply via a secondary electronically controlled gas valve;
a temperature probe in the firebox; and
a control module that controls the primary electronically controlled gas valve and the secondary electronically controlled gas valve to increase or decrease output from the primary burner and the secondary burner, respectively;
wherein the control module thermostatically controls at least the secondary gas valve based on a temperature reading using the temperature probe; and
wherein the primary burner and secondary burner are arranged below the cooking surface to each heat a same area of the cooking surface.

19. The grill of claim 18, wherein a turndown ratio of a highest setting of the primary burner and secondary burner and a lowest setting of the primary burner and secondary burner is about 5:1.

20. The grill of claim 18, wherein a flame pathway exists between the primary burner and secondary burner such that the secondary burner can be turned completely off and then ignited by the primary burner when gas flows from the secondary burner.
